(19) United States
(12) Patent Application Publication
(10) Pub. No.: US 2008/0251271 A1
(43) Pub. Date: Oct. 16, 2008

(54) WATER-RESISTANT WIRE COIL, WIRE WINDING, AND MOTOR, AND METHOD OF INCREASING MOTOR POWER

(76) Inventors: Albert Jeyakumar, Bangalore (IN); Vijay Rajamani, Slingerlands, NY (US)

Correspondence Address: CANTOR COLBURN LLP - SABIC (NORYL), 20 Church Street, 22nd Floor, Hartford, CT, 06103, US

(21) Appl. No.: 11/733,269

(22) Filed: Apr. 10, 2007

(51) Int. Cl. H01B 3/36

(52) U.S. Cl. 174/110 SR

(57) ABSTRACT

A water-resistant wire coil includes a coated wire with a conductor and a covering. The covering is prepared from a composition that includes a poly(arylene ether), a polyolefin, and a hydrogenated block copolymer. The wire coil is useful for the fabrication of wire windings for the rotors and/or stators of water-resistant motors. The covering of the coated wire is thinner than a conventional poly(vinyl chloride) covering. This allows more conductive wire to be incorporated into a rotor and/or stator, which in turn increases the power of the motor.

### BACKGROUND OF THE INVENTION

In an electric motor that includes a rotor and a stator, the rotor or the stator or both can consist of a wire winding in which the wire is insulated with a varnish. The varnish is often a thermoset resin, such as an epoxy resin. However, for motors that are exposed to wet or high-humidity environments, deterioration and or delamination of the varnish can occur. For example, the varnish can peel off the conductor, leading to catastrophic failure. Hence, a more water-resistant insulation is required. One use of such motors is in submersible pumps, where the motors are immersed in water during normal operation, and the windings are exposed to high humidity conditions. One approach to insulating the wires used in the rotors and/or stators of motors exposed to wet environments is to cover the wires with a plastic covering. The plastic covering material needs to have a good balance of flexibility, tensile strength, and electrical insulating properties, among others. Poly(vinyl chloride) is currently the commercially dominant plastic used for this purpose. However, a relatively high thickness of poly(vinyl chloride) is required to achieve the desired electrical insulation properties, and this high insulation thickness limits the power of the motor for a given motor size. Poly(vinyl chloride) is also undesirable because it is a halogenated material subject to regulation in many countries.

Another commercially practiced approach to insulating rotor and/or stator wires is to use a first layer of thermoplastic polyester film (adjacent to the conductor) followed by a second layer of biaxially oriented polypropylene film. Production of this so-called polyester/BOPP insulation requires multiple manufacturing steps and therefore higher manufacturing costs to fabricate compared with a process to form a uniform plastic covering. Moreover, a big disadvantage of this process is that the wrapped winding has to be treated for heat shrink and setting, which further increases the manufacturing cycle time and cost. In practice, polyester/BOPP insulation also appears to be less reliable than poly(vinyl chloride) insulation.

In view of the various disadvantages associated with the use of poly(vinyl chloride) and polyester/BOPP as covering materials for wires used in rotors and/or stators, there is a desire for wire coils, wire windings, and motors in which the coated wire uses a covering material that provides performance equivalent to poly(vinyl chloride) at a significantly lower thickness and that would also allow the use of a manufacturing process that is much simpler than that required to produce polyester/BOPP covering.

### BRIEF DESCRIPTION OF THE INVENTION

The above-described and other drawbacks are alleviated by a water-resistant wire coil, comprising: a coated wire comprising a conductor and a covering; wherein the covering comprises a poly(arylene ether), a polyolefin, and a hydrogenated block copolymer of an alkenyl aromatic compound and a conjugated diene; and wherein the water-resistant wire coil passes a water immersion test every day for 30 consecutive days using a voltage of 3 kilovolts.

Another embodiment is a water-resistant wire coil, comprising: a coated wire comprising a conductor and a covering; wherein the conductor comprises copper; and wherein the covering comprises about 30 to about 55 weight percent poly(2,6-dimethyl-1,4-phenylene ether), about 30 to about 55 weight percent of a polyolefin selected from the group consisting of polyethylene homopolymers, polypropylene homopolymers, and combinations thereof, and about 15 to about 25 weight percent hydrogenated block copolymer comprising about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer, and about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer; wherein all weight percent are based on the total weight of the covering, unless otherwise specified; and wherein the water-resistant wire coil passes a water immersion test every day for 30 consecutive days using a voltage of 3 kilovolts. Another embodiment is a water-resistant wire winding, comprising: a coated wire comprising a conductor and a covering; wherein the covering comprises a poly(arylene ether), a polyolefin, and a hydrogenated block copolymer of an alkenyl aromatic compound and a conjugated diene; and wherein a wire coil consisting of 500 meters of the coated wire passes a water immersion test every day for 30 consecutive days using a voltage of 3 kilovolts.

Another embodiment is a water-resistant wire winding, comprising: a coated wire comprising a conductor and a covering; wherein the conductor comprises copper; and wherein the covering comprises about 30 to about 55 weight percent poly(2,6-dimethyl-1,4-phenylene ether), about 30 to about 55 weight percent of a polyolefin selected from the group consisting of polyethylene homopolymers, polypropylene homopolymers, and combinations thereof, and about 15 to about 25 weight percent hydrogenated block copolymer comprising about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer, and about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer; wherein all weight percent are based on the total weight of the covering, unless otherwise specified; and wherein a wire coil consisting of 500 meters of the coated wire passes a water immersion test every day for 30 consecutive days using a voltage of 3 kilovolts.

Another embodiment is a water-resistant motor, comprising: a stator and a rotor; wherein the stator or the rotor or both comprise a wire winding; wherein the wire winding comprises a coated wire; and wherein the coated wire comprises a conductor, and a covering comprising a poly(arylene ether), a polyolefin, and a hydrogenated block copolymer of an alkenyl aromatic compound and a conjugated diene; and wherein a wire coil consisting of 500 meters of the coated wire passes a water immersion test every day for 30 consecutive days using a voltage of 3 kilovolts.

Another embodiment is a water-resistant motor, comprising: a stator and a rotor; wherein the stator or the rotor or both comprise a wire winding; wherein the wire winding comprises a coated wire; and wherein the coated wire comprises a conductor comprising copper, and a covering comprising about 30 to about 55 weight percent poly(2,6-dimethyl-1,4-phenylene ether), about 30 to about 55 weight percent of a polyolefin selected from the group consisting of polyethylene homopolymers, polypropylene homopolymers, and combinations thereof, and about 15 to about 25 weight percent hydrogenated block copolymer comprising about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer, and about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer; wherein all weight percent are based on the total weight of the covering, unless otherwise specified; wherein a wire coil consisting of 500 meters of the coated wire passes a water immersion test every day for 30 consecutive days using a voltage of 3 kilovolts; and wherein the water-resistant motor passes a water immersion test every day for 30 consecutive days using a voltage of 3 kilovolts, a covering thickness less than or equal to 250 micrometers, and a conductor diameter less than or equal to 2 millimeters.

Another embodiment is a method of increasing the power of a water-resistant motor, comprising: incorporating a rotor and a stator in the motor; wherein the stator or the rotor or both comprises a wire winding; wherein the wire winding comprises a coated wire; wherein the coated wire comprises a conductor, and a covering comprising a poly(arylene ether), a polyolefin, and a hydrogenated block copolymer of an alkenyl aromatic compound and a conjugated diene; and wherein a wire coil consisting of 500 meters of the coated wire passes a water immersion test every day for 30 consecutive days using a voltage of 3 kilovolts.

Another embodiment is a method of increasing the power of a water-resistant motor, comprising: incorporating a rotor and a stator in the motor; wherein the stator or the rotor or both comprise a wire winding; wherein the wire winding comprises a coated wire; wherein the coated wire comprises a conductor and a covering; and increasing the length of coated wire in the wire winding by decreasing the thickness the covering; wherein decreasing the thickness of the covering comprises replacing a poly(vinyl chloride) covering with a covering comprising a poly(arylene ether), a polyolefin, and a hydrogenated block copolymer of an alkenyl aromatic compound and a conjugated diene; wherein a wire coil consisting of 500 meters of the coated wire passes a water immersion test every day for 30 consecutive days using a voltage of 3 kilovolts.

These and other embodiments are described in detail below.

### BRIEF DESCRIPTION OF THE DRAWINGS

Referring now to the drawings wherein like elements are numbered alike in several FIGURES:

FIG. 1 is a photograph of an illustrative water-resistant wire coil;

FIG. 2 is a schematic diagram of a water-resistant wire coil indicating the characteristic inner diameter, outer diameter, and width of the coil;

FIG. 3 is a schematic diagram of the apparatus used in the high voltage water immersion test;

FIG. 4 is a schematic diagram of the apparatus used in the Meggar test; and

FIG. 5 is a photograph of a portion of an illustrative stator comprising a wire winding.

### DETAILED DESCRIPTION OF THE INVENTION

The present inventors have found that many problems associated with prior art water-resistant rotors and stators can be overcome when the rotor and/or stator comprises a wire winding, wherein the wire winding comprises a covered wire that in turn comprises a conductor and a covering comprising a poly(arylene ether), a polyolefin, and a hydrogenated block copolymer. These covering compositions allow lower covering thicknesses than those required for comparably performing poly(vinyl chloride) coverings. In some embodiments, the present covering compositions are also halogen-free, unlike poly(vinyl chloride). The present covering compositions are also better electrical insulators than poly(vinyl chloride). For example, poly(vinyl chloride) has a volume resistivity of about 10¹³ ohm-centimeters at 23° C., whereas the present covering compositions can exhibit a volume resistivity of at least about 10¹⁴ ohm-centimeters at 23° C. The present covering compositions also exhibit better thermal stability than poly(vinyl chloride), as evidenced by a poly(vinyl chloride) service temperature no greater than about 70° C. versus a present covering composition service temperature of at least 80° C. and in some embodiments at least 90° C. Compared to polyester/BOPP insulation, the present covering compositions offer a significantly simplified rotor and/or stator manufacturing process and also allow for insulation of larger diameter conductors.

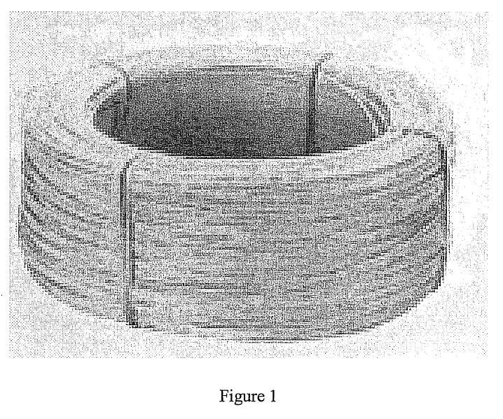

Thus, one embodiment is a water-resistant wire coil, comprising: a coated wire comprising a conductor and a covering; wherein the covering comprises a poly(arylene ether), a polyolefin, and a hydrogenated block copolymer of an alkenyl aromatic compound and a conjugated diene; and wherein the water-resistant wire coil passes a water immersion test every day for 30 consecutive days using a voltage of 3 kilovolts. An illustrative water-resistant wire coil is shown in FIG. 1.

The water-resistant wire coil comprises a coated wire comprising a conductor. The conductor may comprise a single strand or a plurality of strands. In some cases, a plurality of strands may be bundled, twisted, or braided to form a conductor. Additionally, the conductor may have various cross-sectional shapes such as round or oblong. The conductor may be any type of electrical conductor used to transmit a electric power that is either alternating current (AC) or direct current (DC) format. Suitable electrical conductors include copper, aluminum, lead, and alloys comprising one or more of the foregoing metals. The conductor may also be an electrically conductive ink or paste.

In one embodiment the covering composition is applied to a conductor having one or more intervening layers between the conductor and the covering to form a covering disposed over the conductor. For instance, an adhesion promoting layer may, optionally, be disposed between the conductor and covering. In another example the conductor may be coated with a metal deactivator prior to applying the covering. In another example the intervening layer comprises a thermoplastic or thermoset composition that, in some cases, is foamed.

In some embodiments, the covering has a thickness less than or equal to 1 millimeter, specifically less than or equal to 600 micrometers, more specifically less than or equal to 250 micrometers. In some embodiments, the covering has a thickness of about 50 micrometers to 1 millimeter, specifically about 100 to about 600 micrometers, more specifically about 150 to about 250 micrometers.

In some embodiments, the conductor has a diameter of about 0.3 to about 4 millimeters, specifically about 0.9 to about 3 millimeters, more specifically about 1.1 to about 2 millimeters.

In some embodiments, the coated wire has a covering thickness less than or equal to 250 micrometers, and a conductor diameter less than or equal to 2 millimeters, specifically less than or equal to 1.7 millimeters.

The covering composition permits the use of low thicknesses relative to the diameter of the conductor. For example, in some embodiments, the conductor is characterized by a circular cross-section having a radius, the covering is characterized by an annular cross-section having a thickness, and the ratio of the conductor radius to the covering thickness is at least 0.15. In some embodiments, this ratio is 0.15 to about 40, specifically about 0.75 to about 20, more specifically about 1.75 to about 3.

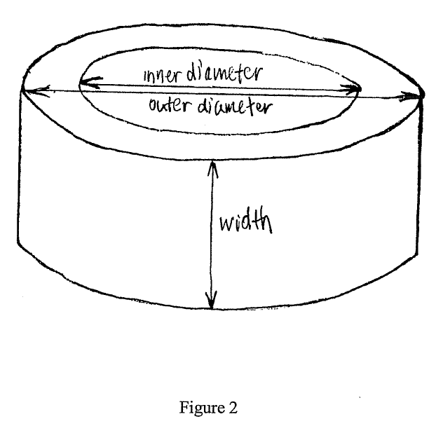

In some embodiments, the wire coil comprises about 100 to about 2000 meters of the coated wire, specifically about 200 to about 1000 meters of the coated wire, more specifically about 400 to about 600 meters of the coated wire, still more specifically about 500 meters of the coated wire. The coil may approximate the shape of a cylinder with a hollow core, wherein the hollow core corresponds to the diameter of the mandrel around which the coated wire was wound to form the coil. The inner diameter of the wire coil, which corresponds to the diameter of the hollow core of the cylinder, may be about 10 to about 30 centimeters, specifically about 15 to about 25 centimeters, more specifically about 20 centimeters. The outer diameter of the wire coil may be about 1 to about 90 centimeters greater than the inner diameter, specifically about 1 to about 60 centimeters greater than the inner diameter. The width of the wire coil, which corresponds to the length of the hollow cylinder, may be about 1 to about 60 centimeters, specifically about 5 to about 20 centimeters, more specifically about 10 to about 15 centimeters. An illustrative wire coil having an inner diameter of about 20 centimeters is shown in FIG. 1. FIG. 2 is a schematic diagram of a water-resistant wire coil indicating the characteristic inner diameter, outer diameter, and width of the coil.

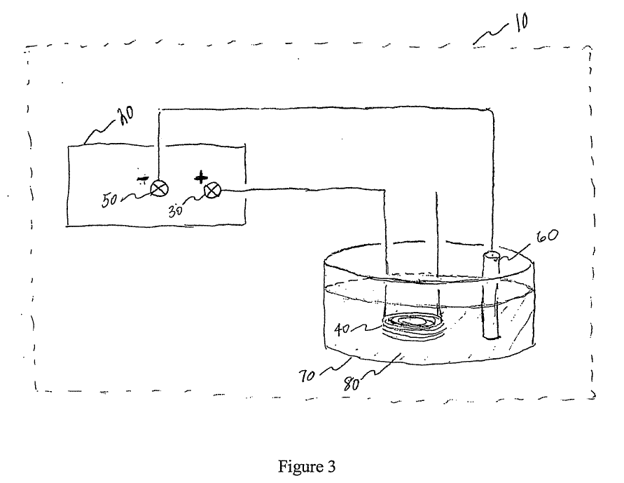

The wire coil is water-resistant. Specifically, it is capable of passing the following water immersion test, which corresponds to the limitation, “wherein the water-resistant wire coil passes a water immersion test every day for 30 consecutive days using a voltage of 3 kilovolts”. The water immersion test can be conducted with a direct current (DC) voltage source or an alternating current (AC) voltage source. An illustrative procedure for conducting the water immersion test with a DC source is as follows. A Kyoritsu High Voltage Insulation Tester Model 3124 may be used. This Tester supplies high voltage from 1 to 10 kilovolts DC and is described at http://www.kew-ltd.co.jp/en/products/insulation/3124.html. The Tester measures the insulation resistance and also has a voltage display. The entire test is conducted at room temperature (about 23° C.). A coil of 500 meters of coated wire is immersed in a water bath with both ends out of the water. Tap water can be used in the water bath. The coil has an internal diameter of about 20 centimeters. A representative coil is pictured in FIG. 1. After 24 hours of water immersion and while still immersed in the water the wire coil is subjected to high voltage that starts at 0.5 kilovolts and is incrementally stepped up to 3 kilovolts over a period of one minute. The voltage of 3 kilovolts is maintained for one minute. The wire coil remains immersed continuously for at least 30 consecutive days, but it is exposed to high voltage for only the two or so minutes per day needed to test the integrity of the insulation. When the insulation is good and can withstand 3 kilovolts for one minute, the voltage display continues to show 3 kilovolts. If there is a failure in the insulation, the voltage immediately drops to less than 10% of its original value (that is, less than 300 volts), and typically to zero volts. A pictorial representation of this apparatus is given in FIG. 3, where high-voltage water immersion apparatus 10 comprises a voltage source 20, a positive terminal 30 connected to wire coil 40, an earthing terminal 50 connected to earthing electrode 60, wherein the entire wire coil except for its wire ends and a portion of the earthing terminal are immersed in water bath 70 containing water 80. The water immersion conducted with a direct current voltage source can use a coil that is not particularly limited by the length of coated wire in the coil. For example, the coil can consist of about 100 to about 2,000 meters of coated wire.

Alternatively, an AC voltage source may be used to conduct the water immersion test. In that case, leakage current, rather than voltage, is monitored. Also, the test must be conducted on a coil consisting of 500 meters or less of coated wire, so if the coil contains more than 500 meters of coated wire, the length of wire is cut down to 500 meters for the test. In the test with the AC voltage source, a breakdown is indicated by an abrupt increase in the current flowing. Insulation is said to fail when a leakage current greater than 500 milliamps is observed at any time during the one minute exposure to 3 kilovolts that takes place each day for 30 consecutive days. Because of the high voltage used, extreme care must be taken when conducting the immersion test. Normally the high voltage test is conducted by personnel trained in high voltage methods.

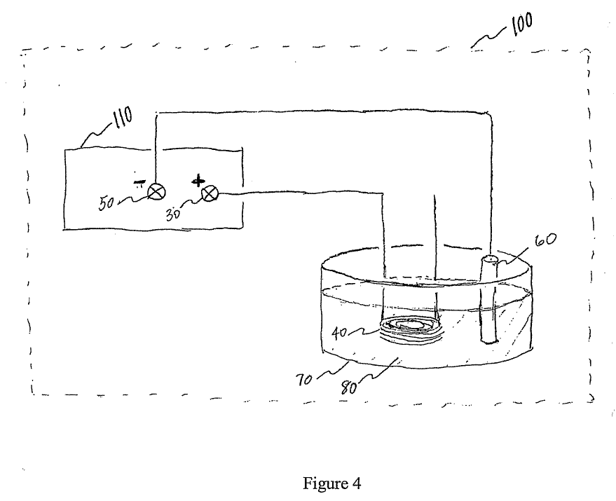

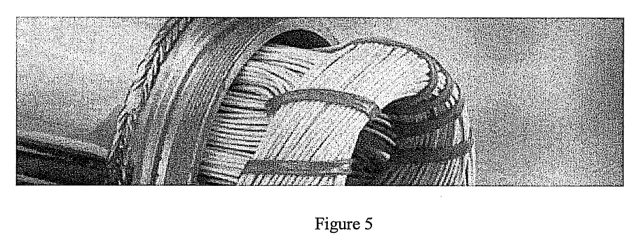

Another objective indicator of the water-resistance of the wire coil is the so-called Meggar test. In some embodiments, a coil consisting of about 100 to about 2,000 meters of the water-resistant coated wire passes a 12-hour Meggar test. The test is performed to check for the insulation resistance and insulation continuity after water immersion of a coil of coated wire or a winding made from the same coated wire. The Meggar test is performed at room temperature using the apparatus schematically depicted in FIG. 3. In FIG. 4, the Meggar test apparatus 100 includes a 2000 megaohm (MΩ) megohmmeter 110, a positive terminal 30 connected to wire coil 40, an earthing terminal 50 connected to earthing electrode 60, wherein the entire wire coil except for its wire ends and a portion of the earthing terminal are immersed in water bath 70 containing water 80, (e.g., tap water). A coil of 500 meters of coated wire is immersed in water for 12 hours. The nearest distance between the wire coil 40 and the earthing electrode 60 is not critical, provided that the wire coil does not touch the water bath wall or the earthing electrode. At the end of twelve hours, resistance is measured at a voltage of 500 volts provided by a DC source. The wire coil stage of the test is passed if the measured resistance is at least 2000 megaohms. If a wire coil passes the coil stage of the Meggar test, it has satisfied the limitation that “a wire coil consisting of 500 meters of the water-resistant coated wire passes a 12-hour Meggar test”. If the coil stage of the test is passed, the same coated wire can be used to prepare a winding of the type used in the stator of an electric motor. The winding has an elliptical shape. The length of wire in a winding depends on the rating of the pump in which it is used, but for the purposes of this test a winding of 500 meters of wire is used. A portion of an illustrative winding is shown in FIG. 5. The winding is inserted into a stator. A motor including the stator and a rotor is assembled and immersed in water for twelve hours using the same apparatus described for the coil Meggar test. At the end of twelve hours, resistance is measured at a voltage of 500 volts. The winding stage of the test is passed if the measured resistance is at least 2000 megaohms. If a coated wire passes the winding stage of the Meggar test, it has satisfied the limitation that “a winding consisting of 500 meters of the water-resistant coated wire passes a 12-hour Meggar test”. The Meggar test is typically employed as a quality control test for every wire coil from which a wire winding is fabricated, and for every wire winding incorporated in a stator.

The covering of the coated wire is soft and flexible. Thus, in some embodiments, test objects molded from the covering composition exhibit a flexural modulus less than or equal to 800 megapascals measured at 23° C. according to ISO 178. This is a 3-point flexural test with a span width of 64 millimeters×10 millimeters. The test specimen is 4 millimeters thick. The rate of cross head motion is 2 millimeters per minute. In some embodiments, the coating composition exhibits a flexural modulus of about 100 to 800 megapascals, specifically about 200 to about 700 megapascals. Another objective indicator of the flexibility of the coating is tensile strength and elongation. In some embodiments, test objects molded from the covering composition exhibit a tensile elongation at break of at least 75 percent, specifically 75 to about 250 percent, measured at 23° C. according to ISO 527 at a pull rate of 50 millimeters per minute.

In some embodiments, the covered wire passes a heat shock test. Heat shock testing is performed by winding a coated wire around a mandrel having a diameter that is 2 to 2.5 times the outer diameter of the covered wire. The mandrel with the wire wound around it is kept at 150° C. for 1 hour. The wire and mandrel are allowed to cool and then the wire is unwound and visually inspected for cracks. The test is passed if no cracks visible to the naked eye are formed.

In some embodiments, the covered wire passes a tensile elongation test conducted on the coated wire itself (in contrast to the tensile elongation test associated with ISO 527 and described above, which is conducted on a test object molded from the covering composition). This test is conducted according to Indian Standard IS: 10810 (Part 7)—1984. A tube of insulation about 100 millimeters long is obtained by carefully removing other components of the insulated conductor without damaging the insulation. A 20-millimeter subsection in the middle of the 100-millimeter section is marked off with a pen. The ends of the 100-millimeter section are pulled in opposite directions at the rate of 250±50 mm/min until the covering breaks. Elongation of the 20-millimeter subsection is measured, and the percent elongation is calculated as 100×[(final length−initial length)/(initial length)]. Passing the test requires a percent elongation at break of at least 125 percent and a tensile strength of at least 12.5 Newtons per square millimeter.

In some embodiments, the covered wire passes a shrinkage test conducted according to Indian Standard IS:10810 (Part 12)—1984, using a sample size of 200 millimeters. The sample is placed in a 150° C. oven for 15 minutes. The specimen is then taken out of the oven and cooled down in air to 27±2 C. Then, the covering length is remeasured and the covering is visually inspected. Passing the test requires a shrinkage of less than or equal to 4% and no visually detectable cracks in the covering.

In some embodiments, the covered wire passes a water absorption test conducted according to Indian Standard IS:10810 (Part 33)—1984. Passing the test requires a weight gain of less than or equal to 2 percent.

In some embodiments, the covered wire passes a hot deformation test conducted according to Indian Standard IS:10810 (Part 15)—1984. A 51 gram load is supported on a covered wire by an edged surface of the load. The sample is maintained at 95° C. for six hours. The diameter of the covered wire at the point of load contact is measured before and after heat exposure. Passing the test requires a less than or equal to 50 percent change in the diameter of the covered wire.

The covering composition comprises a poly(arylene ether). Suitable poly(arylene ether)s include those comprising repeating structural units having the formula

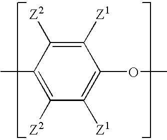

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue may also contain one or more carbonyl groups, amino groups, hydroxyl groups, or the like, or it may contain heteroatoms within the backbone of the hydrocarbyl residue. As one example, Z¹ may be a di-n-butylaminomethyl group formed by reaction of a terminal 3,5-dimethyl-1,4-phenyl group with the di-n-butylamine component of an oxidative polymerization catalyst.

In some embodiments, the poly(arylene ether) comprises 2,6-dimethyl-1,4-phenylene ether units, 2,3,6-trimethyl-1,4-phenylene ether units, or a combination thereof. In some embodiments, the poly(arylene ether) is a poly(2,6-dimethyl-1,4-phenylene ether).

The poly(arylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(arylene ether) can be in the form of a homopolymer, a copolymer, a graft copolymer, an ionomer, or a block copolymer, as well as combinations comprising at least one of the foregoing.

In some embodiments, the poly(arylene ether) has an intrinsic viscosity of about 0.1 to about 1 deciliter per gram measured at 25° C. in chloroform. Specifically, the poly(arylene ether) intrinsic viscosity may be about 0.2 to about 0.8 deciliter per gram, more specifically about 0.3 to about 0.6 deciliter per gram.

The concentration of the poly(arylene ether) in the covering composition can vary substantially according to factors including the desired properties of the covering and the intended use of the covered wire that includes it. In some embodiments, the covering composition comprises the poly(arylene ether) in an amount of about 20 to about 65 weight percent, specifically about 30 to about 50 weight percent, based on the total weight of the covering composition.

In addition to the poly(arylene ether), the covering composition comprises a polyolefin. Polyolefins are of the general structure: CₙH₂ₙ and include polyethylene, polypropylene and polyisobutylene. Exemplary homopolymers include polyethylene, high density polyethylene (HDPE), medium density polyethylene (MDPE), and isotactic polypropylene. Polyolefin resins of this general structure and methods for their preparation are well known in the art.

The polyolefin may also be an olefin copolymer. Such copolymers include copolymers of ethylene and alpha olefins like octene, propylene and 4-methylpentene-1 as well as copolymers of ethylene and one or more rubbers and copolymers of propylene and one or more rubbers. Copolymers of ethylene and C₃-C₁₀ monoolefins and non-conjugated dienes, herein referred to as EPDM copolymers, are also suitable. Examples of suitable C₃-C₁₀ monoolefins for EPDM copolymers include propylene, 1-butene, 2-butene, 1-pentene, 2-pentene, 1-hexene, 2-hexene, 3-hexene, and the like. Suitable dienes include 1,4-hexadiene and monocylic and polycyclic dienes. Mole ratios of ethylene to other C₃-C₁₀ monoolefin monomers can range from 95:5 to 5:95 with diene units being present in the amount of from 0.1 to 10 mole percent. EPDM copolymers can be functionalized with an acyl group or electrophilic group for grafting onto the polyphenylene ether as disclosed in U.S. Pat. No. 5,258,455 to Laughner et al. Olefin copolymers further linear low density polyethylene (LLDPE).

The thermoplastic composition may comprise a single polyolefin homopolymer, a combination of polyolefin homopolymers, a single polyolefin copolymer, a combination of polyolefin copolymers, or a combination comprising a polyolefin homopolymer and a polyolefin copolymer.

In some embodiments the polyolefin is selected from the group consisting of polypropylene, high density polyethylene, and combinations of polypropylene and high density polyethylene. The polypropylene can be homopolypropylene or a polypropylene copolymer. Copolymers of polypropylene and rubber or block copolymers are sometimes referred to as impact modified polypropylene. Such copolymers are typically heterophasic and have sufficiently long sections of each component to have both amorphous and crystalline phases. Additionally the polypropylene may comprise a combination of homopolymer and copolymer, a combination of homopolymers having different melting temperatures, or a combination of homopolymers having different melt flow rates.

In some embodiments the polypropylene comprises a crystalline polypropylene such as isotactic polypropylene. Crystalline polypropylenes are defined as polypropylenes having a crystallinity content greater than or equal to 20%, more specifically greater than or equal to 25%, even more specifically greater than or equal to 30%. Crystallinity content may be determined by differential scanning calorimetry (DSC).

In some embodiments the polypropylene has a melting temperature greater than or equal to 134° C., more specifically greater than or equal to 140° C., even more specifically greater than or equal to 145° C.

The polypropylene has a melt flow rate (MFR) greater than 0.4 grams per 10 minutes and less than or equal to 15 grams per ten minutes (g/10 min). Within this range the melt flow rate may be greater than or equal to 0.6 g/10 min. Also within this range the melt flow rate may be less than or equal to 10, or, more specifically, less than or equal to 6, or, more specifically, less than or equal to 5 g/10 min. Melt flow rate can be determined according to ASTM D1238 using either powdered or pelletized polypropylene, a load of 2.16 kilograms and a temperature of 230° C.

The high density polyethylene can be polyethylene homopolymer or a polyethylene copolymer. Additionally the high density polyethylene may comprise a combination of homopolymer and copolymer, a combination of homopolymers having different melting temperatures, or a combination of homopolymers having different melt flow rates and generally having a density of 0.941 to 0.965 g/cm³.

In some embodiments the high density polyethylene has a melting temperature greater than or equal to 124° C., more specifically greater than or equal to 126° C., even more specifically greater than or equal to 128° C.

The high density polyethylene has a melt flow rate (MFR) greater than or equal to 0.10 grams per 10 minutes and less than or equal to 15 grams per ten minutes (g/10 min). Within this range the melt flow rate may be greater than or equal to 0.5 g/10 min. Also within this range the melt flow rate may be less than or equal to 10, more specifically less than or equal to 6, more specifically less than or equal to 5 g/10 min. Melt flow rate can be determined according to ASTM D1238 using either powdered or pelletized polyethylene, a load of 2.16 kilograms and a temperature of 190° C.

The concentration of the polyolefin in the covering composition can vary substantially according to factors including the desired properties of the covering and the intended use of the covered wire that includes it. In some embodiments, the covering composition comprises the polyolefin in an amount of about 20 to about 60 weight percent, specifically about 30 to about 50 weight percent, based on the total weight of the covering composition.

In addition to the poly(arylene ether), the covering composition comprises a hydrogenated block copolymer of an alkenyl aromatic compound and a conjugated diene. For brevity, this component is referred to herein as the “hydrogenated block copolymer”. The hydrogenated block copolymer may comprise about 15 to about 80 weight percent of poly(alkenyl aromatic) content and about 20 to about 85 weight percent of hydrogenated poly(conjugated diene) content. In some embodiments, the poly(alkenyl aromatic) content is about 20 to 40 weight percent. In other embodiments, the poly(alkenyl aromatic) content is greater than 40 weight percent to about 90 weight percent, specifically about 55 to about 80 weight percent.

In some embodiments, the hydrogenated block copolymer has a weight average molecular weight of about 40,000 to about 400,000 atomic mass units. The number average molecular weight and the weight average molecular weight can be determined by gel permeation chromatography and based on comparison to polystyrene standards. In some embodiments, the hydrogenated block copolymer has a weight average molecular weight of 200,000 to about 400,000 atomic mass units, specifically about 220,000 to about 350,000 atomic mass units. In other embodiments, the hydrogenated block copolymer has a weight average molecular weight of about 40,000 to less than 200,000 atomic mass units, specifically about 40,000 to about 180,000 atomic mass units, more specifically about 40,000 to about 150,000 atomic mass units.

The alkenyl aromatic monomer used to prepare the hydrogenated block copolymer can have the structure

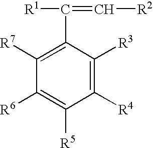

wherein R¹ and R² each independently represent a hydrogen atom, a C₁-C₈ alkyl group, or a C₂-C₈ alkenyl group; R³ and R⁷ each independently represent a hydrogen atom, or a C₁-C₈ alkyl group; and R⁴, R⁵, and R⁶ each independently represent a hydrogen atom, a C₁-C₈ alkyl group, or a C₂-C₈ alkenyl group, or R³ and R⁴ are taken together with the central aromatic ring to form a naphthyl group, or R⁴ and R⁵ are taken together with the central aromatic ring to form a naphthyl group. Specific alkenyl aromatic monomers include, for example, styrene and methylstyrenes such as alpha-methylstyrene and p-methylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene consists of 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a B block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B, wherein the molecular weight of each A block may be the same as or different from that of other A blocks, and the molecular weight of each B block may be the same as or different from that of other B blocks. In some embodiments, the hydrogenated block copolymer is a diblock copolymer, a triblock copolymer, or a combination thereof. In some embodiments, the hydrogenated block copolymer is a polystyrene-poly(ethylene-butylene)-polystyrene triblock copolymer.

In some embodiments, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. In these embodiments it does not comprise grafts formed from these or any other monomers; it also consists of carbon and hydrogen atoms and therefore excludes heteroatoms.

In some embodiments, the hydrogenated block copolymer includes the residue of one or more acid functionalizing agents, such as maleic anhydride.

Methods of preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Polymers as Kraton G1701 and G1702; the polystyrene-poly(ethylene-butylene)-polystyrene triblock copolymers available from Kraton Polymers as Kraton G1641, G1650, G1651, G1654, G1657, G1726, G4609, G4610, GRP-6598, RP-6924, MD-6932M, MD-6933, and MD-6939; the polystyrene-poly(ethylene-butylene-styrene)-polystyrene (S-EB/S-S) triblock copolymers available from Kraton Polymers as Kraton RP-6935 and RP-6936, the polystyrene-poly(ethylene-propylene)-polystyrene triblock copolymers available from Kraton Polymers as Kraton G1730; the maleic anhydride-grafted polystyrene-poly(ethylene-butylene)-polystyrene triblock copolymers available from Kraton Polymers as Kraton G1901, G1924, and MD-6684; the maleic anhydride-grafted polystyrene-poly(ethylene-butylene-styrene)-polystyrene triblock copolymer available from Kraton Polymers as Kraton MD-6670; the polystyrene-poly(ethylene-butylene)-polystyrene triblock copolymer comprising 67 weight percent polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and P2000; the polystyrene-polybutadiene-poly(styrene-butadiene)-polybutadiene block copolymer available from Asahi Kasei Elastomer as S.O.E.-SS L601; the hydrogenated radial block copolymers available from Chevron Phillips Chemical Company as K-Resin KK38, KR01, KR03, and KR05; the polystyrene-poly(ethylene-butylene)-polystyrene triblock copolymer comprising about 60 weight polystyrene available from Kuraray as SEPTON S8104; the polystyrene-poly(ethylene-ethylene/propylene)-polystyrene triblock copolymers available from Kuraray as SEPTON S4044, S4055, S4077, and S4099; and the polystyrene-poly(ethylene-propylene)-polystyrene triblock copolymer comprising about 65 weight percent polystyrene available from Kuraray as SEPTON S2104. Mixtures of two of more hydrogenated block copolymers may be used.

The concentration of the hydrogenated block copolymer in the covering composition can vary substantially according to factors including the desired properties of the covering and the intended use of the covered wire that includes it. In some embodiments, the covering composition comprises the hydrogenated block copolymer in an amount of about 2 to about 40 weight percent, specifically about 15 to about 30 weight percent, based on the total weight of the covering composition. In some embodiments, the covering composition comprises about 15 to about 25 weight percent hydrogenated block copolymer, which in turn comprises about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer, and about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer; wherein all weight percent are based on the total weight of the covering, unless otherwise specified.

The composition may, optionally, further comprise one or more other additives known in the thermoplastics arts. Useful additives include, for example, stabilizers, mold release agents, processing aids, flame retardants, drip retardants, nucleating agents, dyes, pigments, antioxidants, anti-static agents, blowing agents, metal deactivators, antiblocking agents, nanoclays, fragrances (including fragrance-encapsulated polymers), and the like, and combinations thereof. Additives can be added in amounts that do not unacceptably detract from the desired performance and physical properties of the composition. Such amounts can be determined by a skilled artisan without undue experimentation.

In some embodiments, the covering does not comprise a flame retardant. In these embodiments, the composition is distinguished from poly(arylene ether)/polyolefin compositions that include one or more flame retardants such as phosphate esters (including triethyl phosphate, triphenyl phosphate, resorcinol bis(diphenyl phosphate), and bisphenol A bis(diphenyl phosphate)), phosphine oxides (including triphenyl phosphine oxide), alkyl phosphonates, (including ethanephosphonic acid diethyl ester), metal dialkyl phosphinates (including aluminum tris(diethyl phosphinate), melamine type flame retardants (including melamine, melamine cyanurate, melamine phosphate, melamine pyrophosphate, and melamine polyphosphate), zinc borate, boron phosphate, red phosphorus, and the like. Additional flame retardants are described, for example, in U.S. Patent Application Publication No. US 2006/0131059 A1 of Xu et al.; and P. F. Rankin in H. Zweifel, ed., “Plastics Additives Handbook, 5th Edition”, Cincinnati: Hanser (2001), pages 681-698.

In some embodiments, the covering is halogen-free. As used herein, the term “halogen-free” means that no halogen-containing component is intentionally added. In practice, a composition that comprises less than 100 parts per million by weight of total fluorine, chlorine, bromine, and iodine as determined, for example, by Inductively Coupled Plasma Atomic Absorption Spectroscopy is considered halogen-free. In some embodiments, the composition comprises less than 50 parts per million by weight of total fluorine, chlorine, bromine, and iodine.

In some embodiments, the covering comprises about 20 to about 65 weight percent poly(arylene ether), about 20 to about 60 weight percent polyolefin, and about 2 to about 40 weight percent hydrogenated block copolymer; wherein all weight percents are based on the total weight of the covering.

One embodiment is a water-resistant wire coil, comprising: a coated wire comprising a conductor and a covering; wherein the conductor comprises copper; and wherein the covering comprises about 30 to about 55 weight percent poly(2,6-dimethyl-1,4-phenylene ether), about 30 to about 55 weight percent of a polyolefin selected from the group consisting of polyethylene homopolymers, polypropylene homopolymers, and combinations thereof, and about 15 to about 25 weight percent hydrogenated block copolymer comprising about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer, and about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer; wherein all weight percent are based on the total weight of the covering, unless otherwise specified; and wherein the water-resistant wire coil passes a water immersion test every day for 30 consecutive days using a voltage of 3 kilovolts. In some embodiments, the covering does not comprise a flame retardant.

One embodiment is a water-resistant wire winding, comprising: a coated wire comprising a conductor and a covering; wherein the covering comprises a poly(arylene ether), a polyolefin, and a hydrogenated block copolymer of an alkenyl aromatic compound and a conjugated diene; and wherein a wire coil consisting of 500 meters of the coated wire passes a water immersion test every day for 30 consecutive days using a voltage of 3 kilovolts.

One embodiment is a water-resistant wire winding, comprising: a coated wire comprising a conductor and a covering; wherein the conductor comprises copper; and wherein the covering comprises about 30 to about 55 weight percent poly(2,6-dimethyl-1,4-phenylene ether), about 30 to about 55 weight percent of a polyolefin selected from the group consisting of polyethylene homopolymers, polypropylene homopolymers, and combinations thereof, and about 15 to about 25 weight percent hydrogenated block copolymer comprising about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer, and about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer; wherein all weight percent are based on the total weight of the covering, unless otherwise specified; and wherein a wire coil consisting of 500 meters of the coated wire passes a water immersion test every day for 30 consecutive days using a voltage of 3 kilovolts.

One embodiment is a water-resistant motor, comprising: a stator and a rotor; wherein the stator or the rotor or both comprise a wire winding; wherein the wire winding comprises a coated wire; and wherein the coated wire comprises a conductor, and a covering comprising a poly(arylene ether), a polyolefin, and a hydrogenated block copolymer of an alkenyl aromatic compound and a conjugated diene; and wherein a wire coil consisting of 500 meters of the coated wire passes a water immersion test every day for 30 consecutive days using a voltage of 3 kilovolts. Water-resistant motors comprising a rotor and a stator with a wire winding are known in the art. See, for example, the water-resistant motors employed in the submersible pumps described in U.S. Pat. No. 6,218,754 B1 to Alekperov et al., and U.S. Pat. No. 6,599,091 B2 to Nagle. The present water-resistant coated wire may be used to prepare wire windings used in the rotors and/or stators of known water-resistant motors.

In some embodiments, the water-resistant motor is used in a submersible pump that passes a water immersion test every day for 30 consecutive days using a voltage of 3 kilovolts, a covering thickness less than or equal to 250 micrometers, and a conductor diameter less than or equal to 2 millimeters, specifically less than or equal to 1.7 millimeters. The water immersion test for submersible pumps is described as part of Examples 7 and 8, below.

In some embodiments, a winding consisting of 500 meters of the water-resistant coated wire used in the submersible pump passes a water immersion test every day for 30 consecutive days using a voltage of 3 kilovolts.

In some embodiments, the covering of the covered wire used in the submersible pump comprises about 20 to about 65 weight percent poly(arylene ether), about 20 to about 60 weight percent polyolefin, and about 2 to about 40 weight percent hydrogenated block copolymer; wherein all weight percents are based on the total weight of the covering.

One embodiment is a water-resistant motor, comprising: a stator and a rotor; wherein the stator or the rotor or both comprise a wire winding; wherein the wire winding comprises a coated wire; and wherein the coated wire comprises a conductor comprising copper, and a covering comprising about 30 to about 55 weight percent poly(2,6-dimethyl-1,4-phenylene ether), about 30 to about 55 weight percent of a polyolefin selected from the group consisting of polyethylene homopolymers, polypropylene homopolymers, and combinations thereof, and about 15 to about 25 weight percent hydrogenated block copolymer comprising about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer, and about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer; wherein all weight percent are based on the total weight of the covering, unless otherwise specified; wherein a wire coil consisting of 500 meters of the coated wire passes a water immersion test every day for 30 consecutive days using a voltage of 3 kilovolts; and wherein the water-resistant motor passes a water immersion test every day for 30 consecutive days using a voltage of 3 kilovolts, a covering thickness less than or equal to 250 micrometers, and a conductor diameter less than or equal to 2 millimeters. In some embodiments, the covering does not comprise a flame retardant.

Another embodiment is a method of increasing the power of a water-resistant motor, comprising: incorporating a rotor and a stator in the motor; wherein the stator or the rotor or both comprises a wire winding; wherein the wire winding comprises a coated wire; wherein the coated wire comprises a conductor, and a covering comprising a poly(arylene ether), a polyolefin, and a hydrogenated block copolymer of an alkenyl aromatic compound and a conjugated diene; and wherein a wire coil consisting of 500 meters of the coated wire passes a water immersion test every day for 30 consecutive days using a voltage of 3 kilovolts. Use of a thinner wire coating allows for more winding wire to be used, which can lead to a more powerful motor of the same size. Alternatively, a smaller motor can also be designed having the same power rating.

Another method of increasing the power of a water-resistant motor, comprising: incorporating a rotor and a stator in the motor; wherein the stator or the rotor or both comprise a wire winding; wherein the wire winding comprises a coated wire; wherein the coated wire comprises a conductor and a covering; and increasing the length of coated wire in the wire winding by decreasing the thickness the covering; wherein decreasing the thickness of the covering comprises replacing a poly(vinyl chloride) covering with a covering comprising a poly(arylene ether), a polyolefin, and a hydrogenated block copolymer of an alkenyl aromatic compound and a conjugated diene; wherein a wire coil consisting of 500 meters of the coated wire passes a water immersion test every day for 30 consecutive days using a voltage of 3 kilovolts.

The invention is further illustrated by the following non-limiting examples.

### EXAMPLES 1-3

These examples illustrate the preparation and testing of three compositions suitable for use as covering compositions for conductive wire.

The compositions are detailed in Table 1. The poly(arylene ether) was a poly(2,6-dimethyl-1,4-phenylene ether) obtained as PPO 646 from GE Plastics and was characterized by its supplier as having an intrinsic viscosity of 0.46 deciliter per gram measured in chloroform at 25° C. (“PPE” in Table 1). A polypropylene homopolymer having a melt flow rate of 1.4 grams per 10 minutes measured at 230° C. and 2.16 kilogram load was obtained as Pro-fax 7624 from Basell Polyolefins (“Polypropylene” in Table 1). A high density polyethylene (polyethylene homopolymer) was obtained as LR5900-00 from Equistar and was characterized by its supplier as having a density of 0.9435 grams per milliliter and a melt flow rate of 0.7 grams per 10 minutes measured at 190° C. and 2.16 kilogram load (“Polyethylene” in Table 1). The hydrogenated block copolymer for Examples 1 and 2 was a mixture of two polystyrene-poly(ethylene-butylene)-polystyrene triblock copolymers. The first polystyrene-poly(ethylene-butylene)-polystyrene triblock copolymer was obtained as KRATON G1650 from Kraton Polymers and was characterized by its supplier as having a polystyrene content of 30 weight percent (“SEBS G1650” in Table 1). The second polystyrene-poly(ethylene-butylene)-polystyrene triblock copolymer was obtained as TUFTEC H1043 from Asahi Kasei Elastomers and was characterized by its supplier as having a polystyrene content of 67 weight percent (“SEBS Tuftec” in Table 1). The hydrogenated block copolymer for Example 3 was a mixture of the two polystyrene-poly(ethylene-butylene)-polystyrene triblock copolymers described for Examples 1 and 2 plus a third hydrogenated block copolymer which was a polystyrene-poly(ethylene-butylene-styrene)-polystyrene (S-EB/S-S) triblock copolymer obtained from Kraton Polymers as Kraton RP-6936 (“SEBS RP6936” in Table. 1). A linear low density polyethylene having a density of 0.926 grams per milliliter and a melt flow index of about 50 grams per 10 minutes measured at 190° C. and 2.16 kilograms force was obtained from SABIC as M5000026 (“LLDPE” in Table 1). A phosphite stabilizer compound, tris(2,4-di-tert-butylphenyl)phosphite, was obtained as IRGAFOS 168 from Ciba Specialty Chemicals (“Irgafos 168” in Table 1). A hindered phenolic antioxidant was obtained as Irganox 1010 from Ciba Specialty Chemicals (“Irganox 1010” in Table 1). A metal deactivator was obtained as Irganox MD1024 from Ciba Specialty Chemicals (“Irganox MD1024” in Table 1). All component amounts in Table 1 are expressed in parts by weight.

TABLE 1

| | | |
|---|---|---|
| Ex. 1 | Ex. 2 | Ex. 3 |

Compositions

| | | | |
|---|---|---|---|
| PPE | 40 | 40 | 35 |
| Polypropylene | 0 | 40 | 0 |
| Polyethylene | 40 | 0 | 0 |
| SEBS G1650 | 15 | 15 | 29 |
| SEBS Tuftec | 5 | 5 | 5 |
| SEBS RP6936 | 0 | 0 | 18 |
| LLDPE | 0 | 0 | 10 |
| Zinc sulfide | 0.1 | 0.1 | 0.1 |
| Magnesium oxide | 0.1 | 0.1 | 0.1 |
| Irgafos 168 | 0.3 | 0.3 | 0.3 |
| Irganox 1010 | 0.2 | 0.2 | 0.2 |
| Irganox MD1024 | 0.1 | 0.1 | 0.1 |

Properties

| | | | |
|---|---|---|---|
| Flex. Modulus (MPa) | 570 | 484 | 380 |
| Elong. at Break (%) | 150 | 190 | 94 |
| Meggar Test | Pass | Pass | Pass |

Components were blended in a melt kneading process. A dry blend containing the poly(arylene ether), the hydrogenated block copolymers, stabilizers, antioxidant, and metal deactivator was added in the feed throat in a 30-millimeter, 10-zone, twin-screw extruder operating at 350 rotations per minute with barrel temperatures from feed throat to die of 240, 260, 270, and 280° C. The twin-screw extruder uses a downstream feeder in zone 7 out of 10 zones. The zone 7 feeder was used for addition of polyolefin. The feed rate was about 16-18 kilograms per hour (35-40 pounds per hour). The screw design employed had fairly intensive mixing in zones 2 to 4 with relatively mild mixing in zone 9. The extrudate was cooled and pelletized. The compounding process and or the wire coating process may, optionally, employ melt filters comprising 20 to 400 micrometer openings.

For physical property testing, test samples were injection molded using a barrel temperature of 263° C. (505° F.) and a mold temperature of 65.6° C. (150° F.). Flexural modulus values, expressed in megapascals (MPa), were measured at 23° C. according to ISO 178. Values of tensile elongation at break, expressed in percent (%), were measured at 23° C. according to ISO 527. The results in Table 1 show that the three compositions exhibited flexural modulus values ranging from 380 to 570 megapascals and tensile elongation at break values ranging from 94 to 190 percent.

Coated wires used in the Meggar test were prepared by an extrusion coating process. For each composition, pellets that had been dried at 85° C. for 2-5 hours were fed to a three-barrel wire coating extruder. The temperature profile from feed throat to dye was 245, 250, 250, and 250° C. The screw rotation rate was varied to maintain a current less than about 12 amps. The copper conductor was de-dusted, straightened, and pre-heated to 120° C. prior to feeding to the wire-coating die. The water bath was maintained at 25° C. by cooling water circulation. The wire throughput rate was adjusted to maintain a high quality insulation surface. The insulation thickness was controlled by manipulating the extruder screw rotation rate and the pull-rate on the coated wire. Downstream of the water bath, an infrared sensor was used to monitor the outer diameter of the coated wire. Care must be taken to ensure that there are no voids created in the insulation and also that there are no dust particles entrapped in the insulation as this may affect its performance in the water immersion and Meggar tests.

The Meggar test is performed using the apparatus schematically depicted in FIG. 3, which includes a 2000 megaohm (MΩ) megohunmeter. A coil of 500 meters of coated wire is immersed in water for 12 hours. At the end of twelve hours, resistance is measured at a voltage of 500 volts. The coil stage of the test is passed if the measured resistance is at least 2000 megaohms. For Examples 1-3, the Meggar test was conducted using a coated wire consisting of a copper conductor having a diameter of 1.1 millimeters and a covering having a thickness of 250 micrometers. As indicated in Table 1, coated wires prepared from all three compositions passed the Meggar test.

### EXAMPLES 4-6

These examples further illustrate the preparation and testing of covered wires using three different resin compositions in the wire coverings.

Example 4 used a coated wire consisting of a 1.1 millimeter diameter copper conductor and a 450 micrometer thick covering of the Example 2 composition described above. High voltage testing is performed by placing a coil of 500 meters of coated wire in a water bath with both ends out of the water. The apparatus used for this test is schematically depicted in FIG. 2. After 24 hours of water immersion and while still immersed in the water it is subjected to high voltage (direct current) that starts at 0.5 kilovolts and is incrementally stepped up to 3 kilovolts over a period of one minute. The voltage of 3 kilovolts is maintained for one minute. The same procedure is followed every day for a total of at least 30 consecutive days, with the winding remaining continuously immersed in water. This test was conducted on two separate coils. Both coils passed high voltage test when immersed in water for 32 days.

Example 5 was the same as Example 4 except that the Example 1 composition was used for the wire covering and the covering thickness was 250 microns. High voltage testing was conducted on two separate coils. Both coils passed high voltage test when immersed in water for 32 days.

Example 6 was the same as Example 4 except that the Example 3 composition was used for the wire covering, and the covering thickness was 250 micrometers. High voltage testing was conducted on two separate coils. Both coils passed high voltage test when immersed in water for 32 days.

### EXAMPLES 7 AND 8

These examples illustrate testing of covered wires in a submersible pump. The submersible pump had the following specifications: motor power=7.5 kilowatts; rated speed=2800 rpm; head=28.00 meters of mercury; head range=25-31 meters of mercury; rated voltage=415 volts; rated current=19.5 amps; rated frequency=50 Hertz; phase=3. Wire windings for use in the pump stator were prepared using a 1.1 millimeter diameter conductor for Example 7 and a 1.7 millimeter diameter conductor for Example 8. Examples 7 and 8 both used a covering thickness of 250 micrometers prepared from the composition of Example 1. For examples 7 and 8, an AC source was used for the high voltage test.

The wire windings were tested as follows. Wire of desired length is rewound into an elliptical shape and then placed in the stator. The wires are subjected to various secondary operations, which include rewinding, stretching, and bending before they are inserted into the casing. The wire winding is hammered into the casing slot. The pump is assembled with the motor and immersed in water for 30 consecutive days. It is tested according to a high voltage (3 kilovolts) test to understand whether the secondary operations resulted in defects or damage. The test is performed with the whole pump immersed in water for 30 consecutive days. Thus the insulation material has to pass the high voltage test in the form of a winding for a pump motor in addition to passing it as a coil of winding wire immersed in water. The wire windings of Examples 7 and 8 passed all these tests.

The results for all of the working examples above show that the wire coil performs well under water immersion conditions, and that it is suitable for use in wire windings used in the rotors and/or stators of water-resistant motors. Furthermore, its properties are superior to those of the two commercially dominant wires coils and windings for water-resistant motor applications. Compared to a wire coil using a poly(vinyl chloride)-covered wire, the present wire coil exhibits comparable performance at lower covering thickness. For example, for a conductor diameter of 1.1 millimeters, the covered wire of the present wire coil can use a covering thickness of 250 micrometers, whereas a thickness of 350 micrometers is recommended for a poly(vinyl chloride) covering. The ability to use a lower covering thickness, combined with a lower density for the present coverings compared to those prepared from poly(vinyl chloride) results in a substantial weight reduction for devices incorporating the covered wire used in the present wire coil and wire winding. Furthermore, the lower covering thickness allows the use of a longer winding in a given rotor or stator volume or a larger diameter conductor for a given total thickness of the covered wire. Either way, the power of a given size motor is increased. Compared to biaxially oriented polypropylene over the polyester film (BOPP/polyester), the present covered wire has the advantage of avoiding the long cure and set times required for BOPP/polyester. The present covered wire also does not share BOPP/polyester's limitation to conductor diameters less than or equal to 1.9 millimeters. In other words, unlike BOPP/polyester coverings, the present coverings can be used on conductors having diameters of 2 millimeters and greater. So, the covered wire of the present wire coil and wire winding is superior to the two commercially dominant covered wires used in applications where water exposure is a risk.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A water-resistant wire coil, comprising:
a coated wire comprising a conductor and a covering;
wherein the covering comprises
a poly(arylene ether),
a polyolefin, and
a hydrogenated block copolymer of an alkenyl aromatic compound and
a conjugated diene; and
wherein the water-resistant wire coil passes a water immersion test every day for 30 consecutive days using a voltage of 3 kilovolts.

2. The water-resistant wire coil of claim 1, wherein the water immersion test comprises, on each of the 30 consecutive days, applying a voltage of 3 kilovolts direct current for one minute between the wire coil and an earthing electrode in the same water bath as the wire coil; wherein the wire coil passes the water immersion test if the voltage does not fall below 0.3 kilovolts within the one minute period on any of the 30 consecutive days.

3. The water-resistant wire coil of claim 1, wherein the wire coil consists of about 100 to about 2,000 meters of the coated wire.

4. The water-resistant wire coil of claim 1, wherein the wire coil consists of about 250 to about 1,000 meters of the coated wire.

5. The water-resistant wire coil of claim 1, wherein the wire coil consists of about 500 meters of the coated wire.

6. The water-resistant wire coil of claim 1, wherein the water immersion test comprises, on each of the 30 consecutive days, applying a voltage of 3 kilovolts alternating current for one minute between a wire coil consisting of about 100 to 500 meters of coated wire and an earthing electrode in the same water bath as the wire coil; wherein the wire coil passes the water immersion test if a leakage current between the wire coil and the earthing electrode is less than or equal to 500 milliamps for the entire one minute period on each of the 30 consecutive days.

7. The water-resistant wire coil of claim 1, comprising about 100 to about 2000 meters of the coated wire in a shape of a ring defining a hollow core, wherein the ring has an inner diameter of about 10 to about 30 centimeters, an outer diameter about 1 to about 90 centimeters greater than the inner diameter, and a width of about 1 to about 60 centimeters.

8. The water-resistant wire coil of claim 1, wherein the coated wire has a covering thickness less than or equal to 250 micrometers, and a conductor diameter less than or equal to 2 millimeters.

9. The water-resistant wire coil of claim 1, wherein the covering composition exhibits a flexural modulus less than or equal to 800 megapascals measured at 23° C. according to ISO 178.

10. The water-resistant wire coil of claim 1, wherein the covering composition exhibits a flexural modulus of 100 to 800 megapascals measured at 23° C. according to ISO 178.

11. The water-resistant wire coil of claim 1, wherein the covering composition exhibits a tensile elongation at break of at least 75 percent measured at 23° C. according to ISO 527.

12. The water-resistant wire coil of claim 1, wherein the covering composition exhibits a tensile elongation at break of 75 to 250 percent measured at 23° C. according to ISO 527.

13. The water-resistant wire coil of claim 1, wherein a coil consisting of about 100 to about 2,000 meters of the coated wire passes a 12-hour Meggar test.

14. The water-resistant wire coil of claim 1, wherein the covering has a thickness less than or equal to 1 millimeter.

15. The water-resistant wire coil of claim 1, wherein the covering has a thickness of 50 micrometers to 1 millimeter.

16. The water-resistant wire coil of claim 1, wherein the conductor has a diameter of about 0.3 to about 4 millimeters.

17. The water-resistant wire coil of claim 1,
wherein the conductor is characterized by a circular cross-section having a radius;
wherein the covering is characterized by an annular cross-section having a thickness; and
wherein a ratio of the conductor radius to the covering thickness is at least 0.15.

18. The water-resistant coated wire of claim 17, wherein the ratio of the conductor radius to the covering thickness is 0.15 to 40.

19. The water-resistant coated wire of claim 17, wherein the ratio of the conductor radius to the covering thickness is 1.75 to 3.

20. The water-resistant wire coil of claim 1, wherein the covering does not comprise a flame retardant.

21. The water-resistant wire coil of claim 1, wherein the covering is halogen-free.

22. The water-resistant wire coil of claim 1,
wherein the covering comprises
about 20 to about 65 weight percent poly(arylene ether),
about 20 to about 60 weight percent polyolefin, and
about 2 to about 40 weight percent hydrogenated block copolymer;
wherein all weight percents are based on the total weight of the covering.

23. A water-resistant wire coil, comprising:
a coated wire comprising a conductor and a covering;
wherein the conductor comprises copper; and
wherein the covering comprises
about 30 to about 55 weight percent poly(2,6-dimethyl-1,4-phenylene ether),
about 30 to about 55 weight percent of a polyolefin selected from the group consisting of polyethylene homopolymers, polypropylene homopolymers, and combinations thereof, and
about 15 to about 25 weight percent hydrogenated block copolymer comprising
about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer; and
about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer;
wherein all weight percent are based on the total weight of the covering, unless otherwise specified; and
wherein the water-resistant wire coil passes a water immersion test every day for 30 consecutive days using a voltage of 3 kilovolts.

24. The water-resistant wire coil of claim 23, wherein the covering does not comprise a flame retardant.

25. A water-resistant wire winding, comprising:
a coated wire comprising a conductor and a covering;
wherein the covering comprises
a poly(arylene ether),
a polyolefin, and
a hydrogenated block copolymer of an alkenyl aromatic compound and
a conjugated diene; and
wherein a wire coil consisting of 500 meters of the coated wire passes a water immersion test every day for 30 consecutive days using a voltage of 3 kilovolts.

26. The water-resistant wire winding of claim 25, wherein a winding consisting of about 100 to about 2,000 meters of the coated wire passes a 12-hour Meggar test.

27. A water-resistant wire winding, comprising:
a coated wire comprising a conductor and a covering;
wherein the conductor comprises copper; and
wherein the covering comprises
about 30 to about 55 weight percent poly(2,6-dimethyl-1,4-phenylene ether),
about 30 to about 55 weight percent of a polyolefin selected from the group consisting of polyethylene homopolymers, polypropylene homopolymers, and combinations thereof, and
about 15 to about 25 weight percent hydrogenated block copolymer comprising
about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer; and
about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer;
wherein all weight percent are based on the total weight of the covering, unless otherwise specified; and
wherein a wire coil consisting of 500 meters of the coated wire passes a water immersion test every day for 30 consecutive days using a voltage of 3 kilovolts.

28. The water-resistant wire winding of claim 27, wherein the covering does not comprise a flame retardant.

29. A water-resistant motor, comprising:
a stator and a rotor;
wherein the stator or the rotor or both comprise a wire winding;
wherein the wire winding comprises a coated wire; and
wherein the coated wire comprises
a conductor, and
a covering comprising
a poly(arylene ether),
a polyolefin, and
a hydrogenated block copolymer of an alkenyl aromatic compound and a conjugated diene; and
wherein a wire coil consisting of 500 meters of the coated wire passes a water immersion test every day for 30 consecutive days using a voltage of 3 kilovolts.

30. The water-resistant motor of claim 29, wherein a submersible pump comprising the water-resistant motor passes a water immersion test every day for 30 consecutive days using a voltage of 3 kilovolts, a covering thickness less than or equal to 250 micrometers, and a conductor diameter less than or equal to 2 millimeters.

31. The water-resistant motor of claim 30, wherein the ratio of the conductor radius to the covering thickness is 1.75 to 3.

32. The water-resistant motor of claim 29,
wherein the covering comprises
about 20 to about 65 weight percent poly(arylene ether),
about 20 to about 60 weight percent polyolefin, and
about 2 to about 40 weight percent hydrogenated block copolymer;
wherein all weight percents are based on the total weight of the covering.

33. A water-resistant motor, comprising:
a stator and a rotor;
wherein the stator or the rotor or both comprise a wire winding;
wherein the wire winding comprises a coated wire; and
wherein the coated wire comprises
a conductor comprising copper, and
a covering comprising
about 30 to about 55 weight percent poly(2,6-dimethyl-1,4-phenylene ether),
about 30 to about 55 weight percent of a polyolefin selected from the group consisting of polyethylene homopolymers, polypropylene homopolymers, and combinations thereof, and
about 15 to about 25 weight percent hydrogenated block copolymer comprising
about 3 to about 8 weight percent of a first polystyrene-poly(ethylene-butylene)-polystyrene triblock copolymer having a polystyrene content of about 55 to about 80 weight percent based on the weight of the first polystyrene-poly(ethylene-butylene)-polystyrene triblock copolymer; and
about 10 to about 20 weight percent of a second polystyrene-poly(ethylene-butylene)-polystyrene triblock copolymer having a polystyrene content of about 20 to about 40 weight percent based on the weight of the second polystyrene-poly(ethylene-butylene)-polystyrene triblock copolymer;
wherein all weight percent are based on the total weight of the covering, unless otherwise specified;
wherein a wire coil consisting of 500 meters of the coated wire passes a water immersion test every day for 30 consecutive days using a voltage of 3 kilovolts; and
wherein the water-resistant motor passes a water immersion test every day for 30 consecutive days using a voltage of 3 kilovolts, a covering thickness less than or equal to 250 micrometers, and a conductor diameter less than or equal to 2 millimeters.

34. The water-resistant motor of claim 33, wherein the covering does not comprise a flame retardant.

35. A method of increasing the power of a water-resistant motor, comprising:
incorporating a rotor and a stator in the motor;
wherein the stator or the rotor or both comprises a wire winding;
wherein the wire winding comprises a coated wire;
wherein the coated wire comprises
a conductor, and
a covering comprising
a poly(arylene ether),
a polyolefin, and
a hydrogenated block copolymer of an alkenyl aromatic compound and a conjugated diene; and
wherein a wire coil consisting of 500 meters of the coated wire passes a water immersion test every day for 30 consecutive days using a voltage of 3 kilovolts.

36. A method of increasing the power of a water-resistant motor, comprising:
incorporating a rotor and a stator in the motor; wherein the stator or the rotor or both comprise a wire winding; wherein the wire winding comprises a coated wire; wherein the coated wire comprises a conductor and a covering; and
increasing the length of coated wire in the wire winding by decreasing the thickness the covering; wherein decreasing the thickness of the covering comprises replacing a poly(vinyl chloride) covering with a covering comprising
a poly(arylene ether),
a polyolefin, and
a hydrogenated block copolymer of an alkenyl aromatic compound and
a conjugated diene;
wherein a wire coil consisting of 500 meters of the coated wire passes a water immersion test every day for 30 consecutive days using a voltage of 3 kilovolts.
